(19) United States
(12) Patent Application Publication
(10) Pub. No.: US 2019/0219000 A1
(43) Pub. Date: Jul. 18, 2019

(54) ACOUSTIC ATTENUATION SYSTEM FOR NACELLE STRUCTURES AND METHOD THEREFOR

(71) Applicant: The Boeing Company, Chicago, IL (US)

(72) Inventor: Jonathan Joseph REED, Bothell, WA (US)

(21) Appl. No.: 15/869,223

(22) Filed: Jan. 12, 2018

(51) Int. Cl. F02K 1/82; B64D 33/02

(52) U.S. Cl. CPC F02K 1/827; B64D 33/02; F02K 1/72; B64D 2033/0273; B64D 2033/0206

(57) ABSTRACT

An engine nacelle structure including a fan duct having a fan duct wall. The fan duct wall including a latticed frame having circumferentially extending frame members and longitudinally extending frame members, the circumferentially extending frame members and longitudinally extending frame members form a plurality of bays therebetween, and a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic panels.

### BACKGROUND

### 1. Field

The exemplary embodiments generally relate to acoustic attenuation of gas turbine engines and in particular to acoustic attenuation panels for nacelle structures of the gas turbine engines.

### 2. Brief Description of Related Developments

Bypass gas turbine engines (also referred to as jet engines) are used by many commercial passenger aircraft for propulsion. In a bypass turbine engine, ambient air enters an engine inlet and is pressurized and accelerated rearwardly by a fan located near the inlet. A relatively small portion of the pressurized air from the fan is passed into a core engine where the air is mixed with fuel and ignited causing combustion and expansion of the fuel-air mixture. The Expansion of the fuel-air mixture drives the fan. The discharge of the combustion gas from the exhaust nozzle adds to the propulsive thrust of the gas turbine engine. A relatively large portion of the pressurized air from the fan bypasses the core engine and passes through a fan duct that surrounds the core engine. The air exiting the fan duct may provide a significant portion of the propulsive thrust of the gas turbine engine.

In certain bypass turbine engines such as those having thrust reversers, the fan duct is bifurcated or divided by a pair of inner walls into two semi-circular fan ducts. Each one of the inner walls may include a semi-circular barrel portion that generally surrounds the core engine. The inner wall may also include an upper wall portion and a lower wall portion extending radially from circumferential ends of the barrel portion. The upper and lower wall portion may be coupled to diametrically-opposite sides (e.g., upper and lower sides) of a fan duct outer wall (e.g., a fan reverser cowl). The bifurcated fan duct arrangement provides improved accessibility to the engine interior for inspection and maintenance.

Noise reduction requirements for gas turbine engines generally include acoustic attenuation in the thrust reverser and primary exhaust portions of the gas turbine engines. Conventionally acoustic attenuation in at least the thrust reverser portion of the gas turbine engine includes composite acoustic paneling having a thermal protections system. These composite acoustic panels are generally replaced frequently due to, e.g., the heat experienced by the composite acoustic panels within the gas turbine engines, which may lead to increased operational costs for the aircraft. Other conventional acoustic attenuation in at least the thrust reverser portion of the engine includes metallic acoustic paneling however; manufacture of the metallic acoustic paneling is costly and may increase the production and operational costs of the aircraft.

### SUMMARY

Accordingly, apparatuses and methods, intended to address at least one or more of the above-identified concerns, would find utility.

The following is a non-exhaustive list of examples, which may or may not be claimed, of the subject matter according to the present disclosure.

One example of the subject matter according to the present disclosure relates to an engine nacelle structure comprising: a fan duct having a fan duct wall, the fan duct wall including a latticed frame having circumferentially extending frame members and longitudinally extending frame members, the circumferentially extending frame members and longitudinally extending frame members form a plurality of bays therebetween, and a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic panels.

Another example of the subject matter according to the present disclosure relates to a vehicle comprising: a frame; and at least one gas turbine engine coupled to the frame, the at least one gas turbine engine having a fan duct wall, the fan duct wall including a latticed frame having circumferentially extending frame members and longitudinally extending frame members, the circumferentially extending frame members and longitudinally extending frame members form a plurality of bays therebetween, and a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic panels.

Still another example of the subject matter according to the present disclosure relates to a method for providing acoustic attenuation to a fan duct of an engine nacelle, the method comprising: removably coupling a plurality of acoustic attenuation panels to a latticed frame so as to form an acoustic attenuation assembly, where the latticed frame has circumferentially extending frame members and longitudinally extending frame members forming a plurality of bays therebetween, and each acoustic attenuation panel is coupled to the latticed frame within a respective one of the plurality of bays so that the acoustic attenuation panel is configured to be coupled to and removed from the latticed frame independent of other ones of the plurality of acoustic panels; and coupling the acoustic attenuation assembly to the engine so that the latticed frame, and the plurality of acoustic attenuation panels removably coupled thereto, form a fan duct wall of the fan duct of the engine nacelle.

### BRIEF DESCRIPTION OF THE DRAWINGS

Having thus described examples of the present disclosure in general terms, reference will now be made to the accompanying drawings, which are not necessarily drawn to scale, and wherein like reference characters designate the same or similar parts throughout the several views, and wherein:

FIG. 1 is a perspective view of a vehicle incorporating aspects of the present disclosure;

FIG. 2 is a side view of a gas turbine engine taken along line 2-2 of FIG. 1, the gas turbine engine incorporating aspects of the present disclosure;

FIG. 3 is a sectional view of the gas turbine engine of FIG. 2, taken along line 3-3 of FIG. 2, in accordance with aspects of the present disclosure;

FIG. 4 is a view looking aft at the gas turbine engine taken along line 4-4 of FIG. 2 in accordance with aspects of the present disclosure;

FIG. 5 is a cross sectional view of an acoustic attenuation assembly of the gas turbine engine of FIG. 2 in accordance with aspects of the present disclosure;

FIG. 6 is a cross sectional view of an acoustic attenuation assembly of the gas turbine engine of FIG. 2 in accordance with aspects of the present disclosure;

FIG. 7 is a cross sectional view of an acoustic attenuation assembly of the gas turbine engine of FIG. 2 in accordance with aspects of the present disclosure;

FIG. 8A is a cross sectional view of an acoustic attenuation assembly of the gas turbine engine of FIG. 2 in accordance with aspects of the present disclosure;

FIG. 8B is a partial side perspective view of the latticed frame in accordance with aspects of the present disclosure;

FIG. 9A is a sectional side view of a portion of an acoustic attenuation panel in accordance with aspects of the present disclosure;

FIG. 9B is a sectional side view of a portion of an acoustic attenuation panel in accordance with aspects of the present disclosure;

FIG. 10 is a top view of a portion of an acoustic attenuation panel in accordance with aspects of the present disclosure;

FIG. 11 is an exemplary flow diagram for a method of providing acoustic attenuation to a fan duct of an engine nacelle in accordance with aspects of the present disclosure; and

FIG. 12 is an exemplary flow diagram of a vehicle production and service methodology.

### DETAILED DESCRIPTION

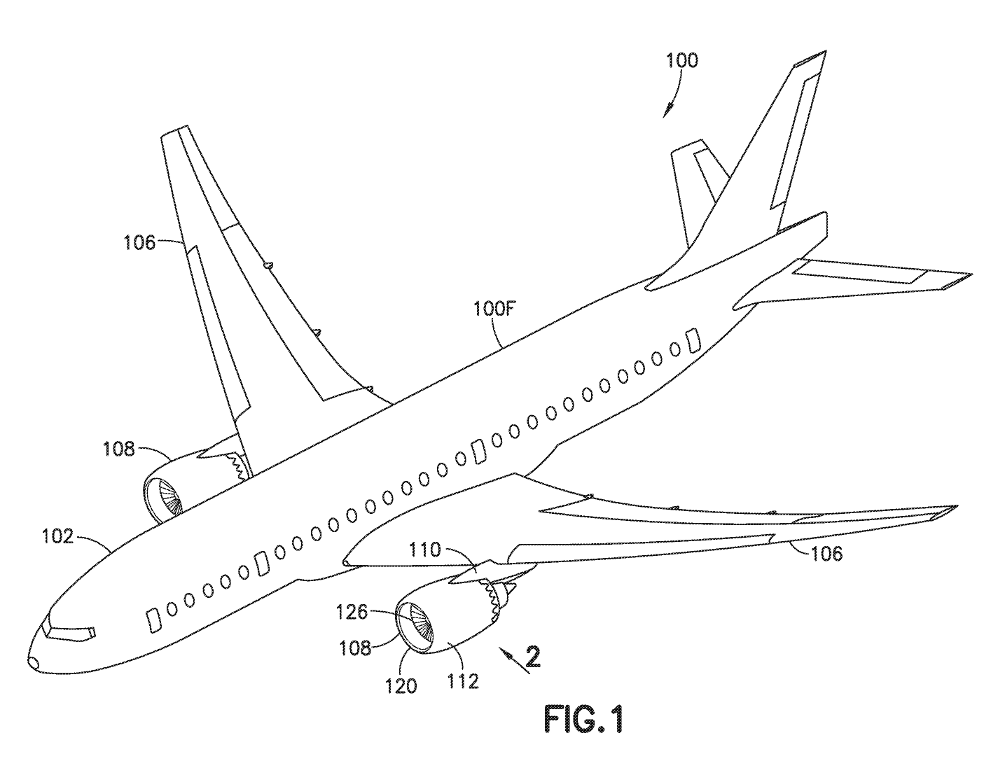

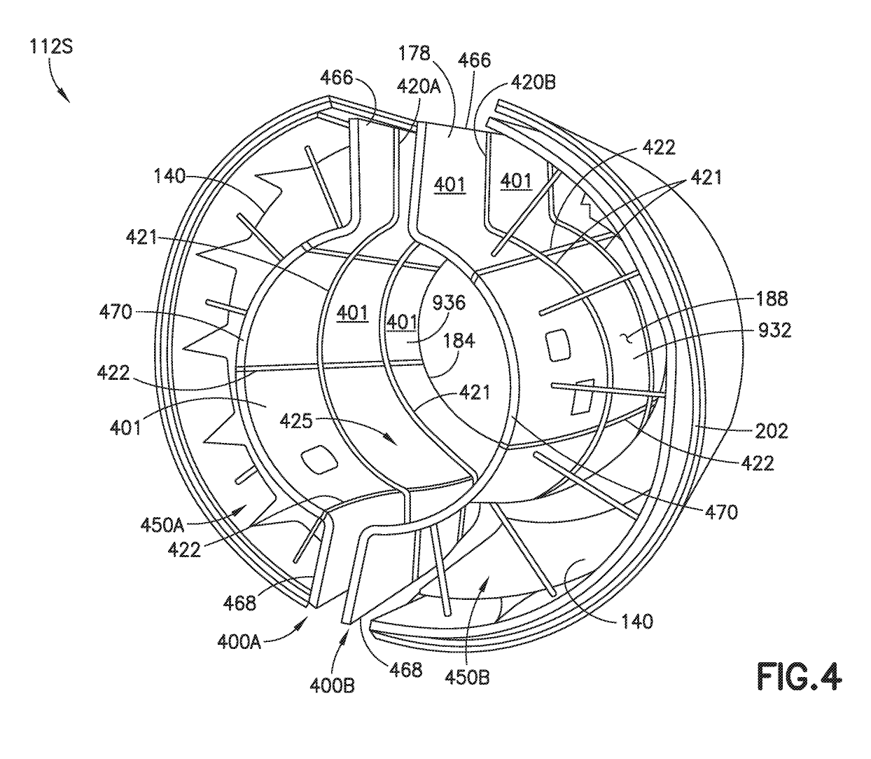

Referring to FIGS. 1 and 4, the aspects of the present disclosure provide for acoustic attenuation in at least a thrust reverser portion of a gas turbine engine 108 of the vehicle 100 (which in the example provided herein is an aircraft). The aspects of the present disclosure provide at least one acoustic attenuation assembly 400A, 400B where each acoustic attenuation assembly includes at least two high temperature metallic acoustic attenuation panels 401 removably coupled to a latticed frame 420A, 420B. The at least one acoustic attenuation assembly 400A, 400B has substantially the same complex contours and aerodynamic profiles as conventional composite panels. Each of the acoustic attenuation panels 401 may be removed (e.g., decoupled) from and installed (e.g., coupled) to the latticed frame 420A, 420B independently from other acoustic attenuation panels 401 such that repair or replacement of worn acoustic attenuation panels is limited to only the affected (e.g., worn and/or at an end of its service life) acoustic attenuation panels, while other (e.g., unaffected) acoustic attenuation panels remain installed on the latticed frame 420A, 420B. The modular confirmation of the at least one acoustic attenuation assembly 400A, 400B may reduce repair costs of the vehicle 100 through replacement of only the affected acoustic attenuation panels.

While the aspects of the present disclosure are described herein with respect to the vehicle 100, it should be understood that the aspects of the present disclosure may be employed where sound attenuation of a gas turbine engine may be desired. For example, the aspects of the present disclosure may not only be used on fixed wing jet powered aircraft, but may also be used on jet powered rotary wing aircraft, maritime vessels, and automobiles. Further, while the aspects of the present disclosure are described herein with respect to the fan duct 160 portion of the gas turbine engine, the aspects of the present disclosure may be applied to any suitable portion of the gas turbine engine such as, but not limited to, the engine inlet, nozzle, thrust reversers, and plug.

Illustrative, non-exhaustive examples, which may or may not be claimed, of the subject matter according to the present disclosure are provided below.

Referring to FIG. 1, a perspective view of an exemplary vehicle 100 incorporating features of the present disclosure is illustrated. For example, the vehicle 100 may include one or more gas turbine engines 108 (such as a gas turbine engine) where the one or more gas turbine engines 108 incorporate at least one acoustic attenuation assembly 400A, 400B (see FIG. 4) in accordance with the aspects of the present disclosure. The vehicle 100 may include an airframe 100F that forms at least a fuselage 102. The vehicle 100 may also include a pair of wings 106 coupled to the fuselage 102 where the one or more gas turbine engines 108 are coupled to a respective wing 106 by struts (also referred to as pylons) 110.

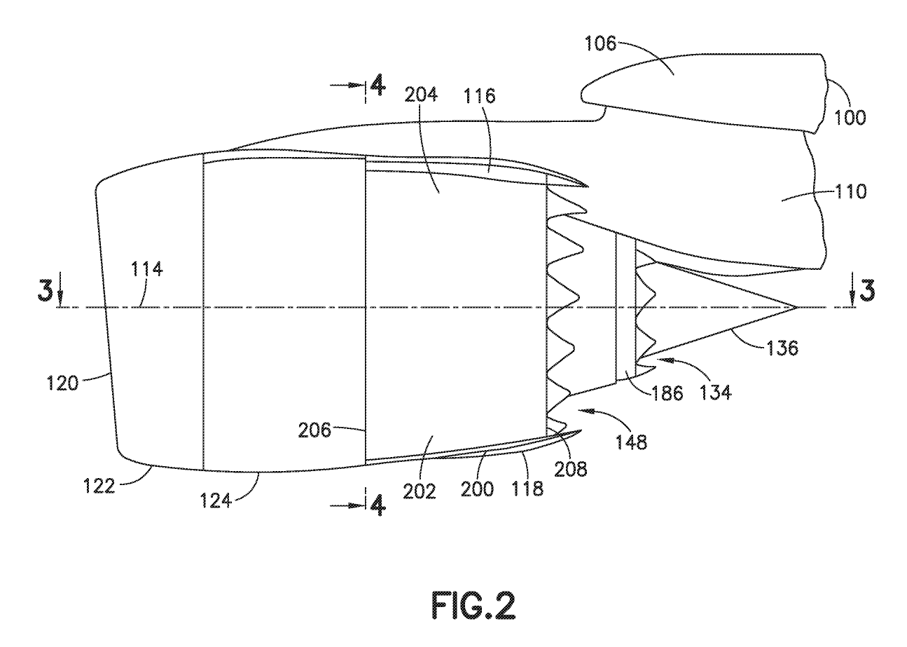

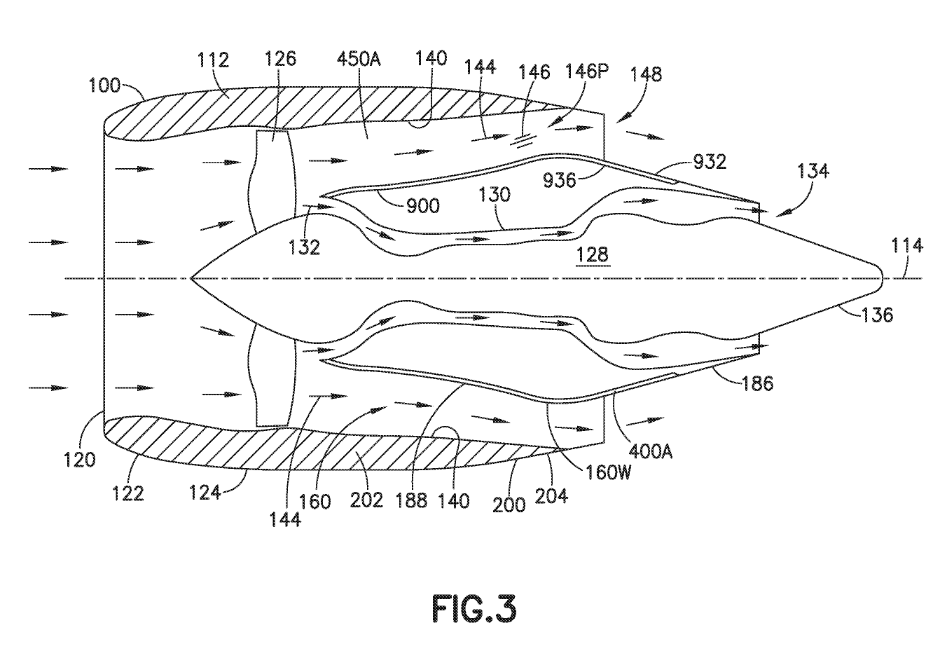

Referring to FIGS. 1 and 2, each of the one or more gas turbine engines 108 may include an engine nacelle 112 that may be coupled a respective wing 106 of the vehicle 100 by the struts 110. In one aspect, at least a portion of the engine nacelle 112 is coupled to the wing 106 through the gas turbine engine 108, where the engine nacelle 112 is coupled to the engine in any suitable manner. The gas turbine engine 108 may include an inlet 120 defined by an inlet cowl 122 located at a forward end of the gas turbine engine 108. The gas turbine engine may also include a fan cowl 124 for housing a fan 126 (FIG. 3). The fan 126 may pressurize air entering the inlet 120 and may accelerate a fluid flow 144 rearwardly through a fan duct 160 having a fan duct wall 160W formed by the at least one acoustic attenuation assembly 400A, 400B (FIG. 4). In one aspect, the fan duct wall 160W is a bifurcated wall which is formed from respective bifurcation assemblies (or bifurcated fan ducts) 450A, 450B (FIG. 4) of the engine nacelle 112, where the bifurcation assemblies 450A, 450B each comprise a respective acoustic attenuation assembly 400A, 400B.

Still referring to FIG. 2, the gas turbine engine 108 may also include a thrust reverser assembly 200 having fan reverser cowls 202 including translating sleeve(s) 204 configured to move forward and aft for thrust reversal. Each one of the translating sleeves 204 may have a sleeve forward end 206 and a sleeve aft end 208. The sleeve aft end 208 and the aft cowl 186 may collectively form a fan nozzle 148 for the bifurcation assemblies 450A, 450B (FIG. 4), which comprise the at least one acoustic attenuation assembly 400A, 400B (FIG. 4). The fan reverser cowls 202 may be supported by a hinge beam 116 on a top of the engine nacelle 112 and a latch beam 118 on a bottom of the nacelle to allow the fan reverser cowls 202 to be pivoted upwardly along the hinge beam 116 for access to the engine interior for inspection and maintenance. The gas turbine engine 108 may include a primary exhaust nozzle 134 at an aft end of the gas turbine engine 108. The primary exhaust nozzle 134 may be defined by the aft cowl 186 and a primary exhaust plug 136.

Referring to FIG. 3, shown is a horizontal cross-sectional view of the gas turbine engine 108 illustrated in FIG. 2. In FIG. 3, the fan 126 may be housed within the fan cowl 124. The fan 126 may be mounted to a shaft (not shown) extending forward from the core engine 128. The core engine 128 may be housed within an engine core cowl 130. The fan 126 may be rotatable about the engine longitudinal axis 114 for drawing fluid (such as air) into the inlet 120 and pressurizing and/or accelerating the fluid rearwardly through the fan duct 160. A portion of the fluid may pass through/along a core flow path 132 and may enter the core engine 128 where the fluid may be mixed with fuel and ignited causing combustion thereof. Combustion gas may be discharged through the primary exhaust nozzle 134.

In FIG. 3, the fluid flow 144 pressurized by the fan 126 may flow rearwardly through the bifurcation assemblies 450A, 450B (see also FIG. 4, only bifurcated fan duct 450A is illustrated in FIG. 3) located on opposite sides of the gas turbine engine 108. Each one of the bifurcation assemblies 450A, 450B may be defined by a semi-circular outer wall 140 (e.g., a fan reverser cowl 202) and an acoustic attenuation assembly 400A, 400B (see also FIG. 4, only acoustic attenuation assembly 400A is illustrated in FIG. 3). The acoustic attenuation assembly 400A, 400B may form a portion of the fan duct wall 160W, such as an inner wall, of a respective bifurcated fan duct 450A, 450B. Each one of the acoustic attenuation assemblies 400A, 400B may be positioned along (e.g., oriented generally parallel to) a duct fluid flow path 146 of the fluid flow 144. The aft cowl 186 may be mounted to the inner wall panel aft end 184 (FIG. 4). Each acoustic attenuation assembly 400A, 400B may have an axial contour 178 (FIG. 4) along a direction of the engine longitudinal axis 114 of the gas turbine engine 108. The axial contour 178 of the acoustic attenuation assembly 400A, 400B may comprise a compound curvature of varying radii in the acoustic attenuation assembly 400A, 400B. The acoustic attenuation assembly 400A, 400B may have a fluid flow surface 188 that may be exposed to the fluid flow 144 moving along the duct fluid flow path 146.

Referring to FIG. 4, a view looking aft at an engine nacelle structure 112S (such as a portion of the thrust reverser assembly 200) of the gas turbine engine 108 is provided. Each acoustic attenuation assembly 400A, 400B may extend between upper and lower sides or surfaces of the semi-circular outer walls 140. The acoustic attenuation assemblies 400A, 400B may generally be formed as mirror images of each other but, in other aspects, one acoustic attenuation assembly 400A, 400B may have a surface contour that is different than the other acoustic attenuation assembly 400A, 400B. The fan duct wall 160W formed by a respective acoustic attenuation assembly 400A, 400B comprises an arcuate portion 470 and at least one flange portion 466, 468 extending radially from the arcuate portion. For example, the at least one flange portion 466, 468 may include a first and second flange portions 466, 468 each being substantially planar and extending radially outward from circumferentially opposite ends of the arcuate portion 470. Each of the acoustic attenuation assembly 400A, 400B includes, or is otherwise defined by, a latticed frame 420A, 420B and at least two acoustic attenuation panels 401.

The latticed frame 420A, 420B has circumferentially extending frame members 421 and longitudinally (e.g., extending generally along the direction of engine longitudinal axis 114—see FIG. 3) extending frame members 422 that are contoured so as to, at least in part, form the fluid flow surface 188. The circumferentially extending frame members 421 and longitudinally extending frame members 422 form a plurality of bays 425 therebetween. In one aspect, the arcuate portion 470 includes at least two bays 425 while in other aspects, the arcuate portion 470 may have any number of bays 425. In one aspect, the at least one flange portion 466, 468 includes at least one bay 425 while in other aspects, the at least one flange portion 466, 468 includes any suitable number of bays 425. In one aspect, the number of bays 425 may depend on the shape/contour of the fan duct wall 160W. For example, a more complex shape having many contour changes may have an increased number of bays 425 than a less complex shape having a fewer number of contour changes. As another example, portions of the arcuate portion 470 with smaller radii may have an increased number of bays compared to portions of the arcuate portion 470 with larger radii. The increased number of bays provides for smaller (e.g., in length and width) acoustic attenuation panels 401 where the smaller acoustic attenuation panels may lend themselves to less complex manufacturing techniques (e.g., the smaller acoustic attenuation panels may be manufactured with less surface contour, such as substantially flat panels, but when placed within the latticed frame may form a desired surface contour of the fan duct wall 160W).

In one aspect, the circumferentially extending frame members 421 and longitudinally extending frame members 422 may be constructed of any suitable material configured to withstand the temperatures experienced within the gas turbine engine 108 (e.g., such as for example, about −40° F. (or lower) to about 800° F.-1000° F. (or higher)) and temperature gradients of up to about 400° F.-500° F. or greater across the surfaces of the frame members. Examples of suitable materials include, but are not limited to titanium alloys, steel alloys, nickel alloys, or any other suitable alloy.

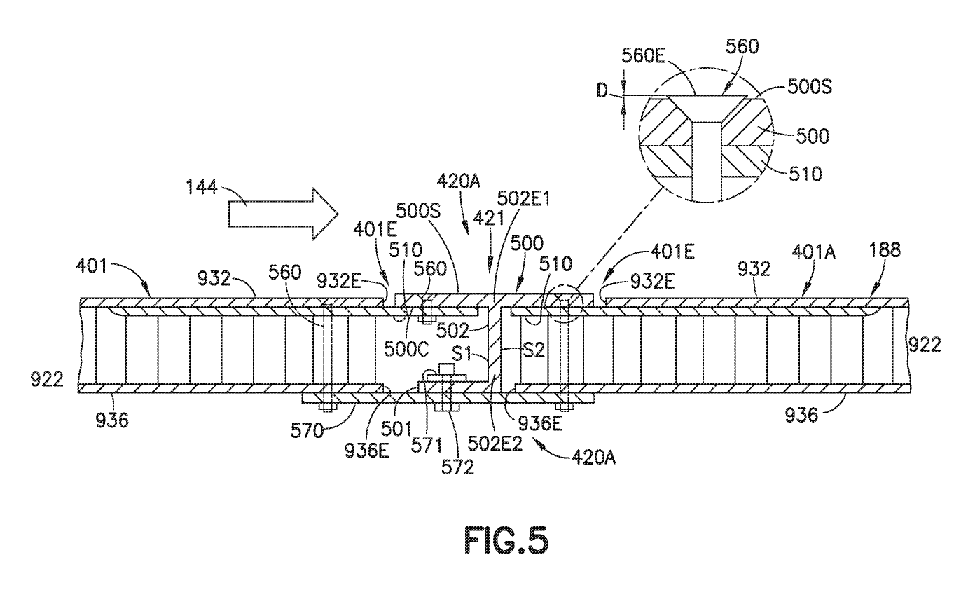

Referring to FIGS. 4-8A, each of the circumferentially extending frame members 421 and longitudinally extending frame members 422 may have any suitable shape for coupling with respective acoustic attenuation panels 401. It is noted that the shape of the circumferentially extending frame members 421 and longitudinally extending frame members 422 will be described with respect to the circumferentially extending frame members 421, a cross section of which is shown in FIGS. 5-8A. It should be understood that the longitudinally extending frame members 422 are shaped similarly to the circumferentially extending frame members 421 where the longitudinally extending frame members 422 and the circumferentially extending frame members 421 are coupled to each other in any suitable manner (e.g., with removable fasteners, non-removable fasteners, welding, etc.) to form the latticed frame 420A, 420B. Each of the circumferentially extending frame members 421 includes a first flange member 500, a second flange member 501 and a stanchion 502. The stanchion 502 is coupled, at a first end 502E1, to the first flange member 500 so that the first flange member 500 laterally extends from opposite lateral sides S1, S2 of the stanchion 502. The first flange member 500 includes a fluid flow surface 500S, that forms at least a part of the fluid flow surface 188, and an acoustic attenuation panel coupling surface 500C. The stanchion 502 is coupled, at a second end 502E2, to the second flange member 501 so that the second flange member 501 extends laterally from at least one lateral side S1, S2 of the stanchion 502. The first flange member, 500, the second flange member 501 and the stanchion 502 may form a partial “I” beam (e.g., having a “J” shape like the corresponding capital letter “J” in the English alphabet) or an “I” beam (not shown but, e.g., having an “I” shape like the corresponding capital letter “I” in the English alphabet). In other aspects the circumferentially extending frame members 421 and longitudinally extending frame members 422 may have any suitable cross-sectional shape that supports the acoustic attenuation panels 401 and forms at least a portion of the fluid flow surface 188.

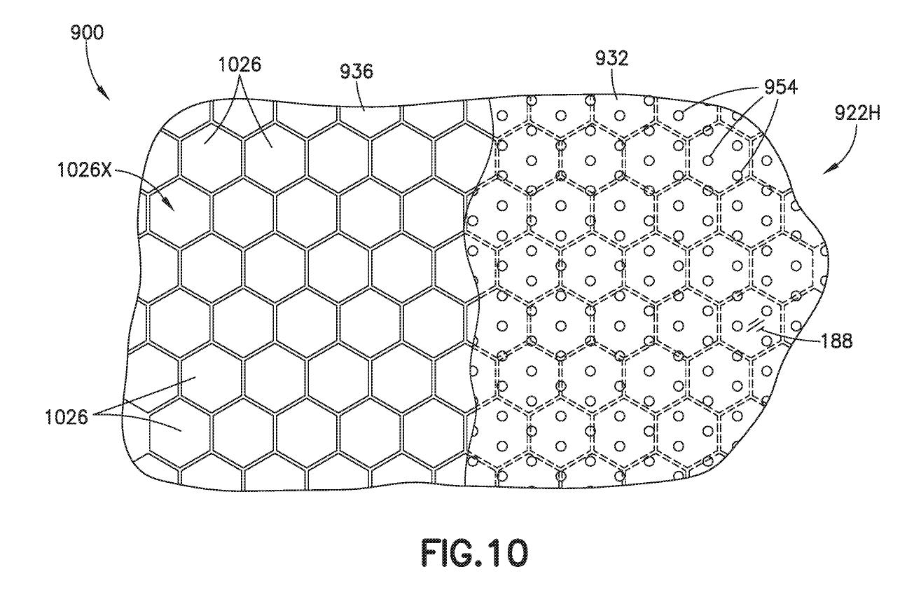

Referring to FIGS. 4, 9A, 9B and 10, the acoustic attenuation panels 401 may have any suitable configuration for attenuating sound emanating from the gas turbine engine 108 (FIG. 1). The acoustic attenuation panels 401 may include a first face sheet 932, a second face sheet 936 and a tubular core 922. The first face sheet 932 includes perforations 954 that interface with the fluid flow 144 through the engine nacelle structure 112S. The second face sheet 936 may be a non-perforated or solid sheet. The tubular core 922 is disposed between the first face sheet 932 and the second face sheet 936, where the perforations 954 in the first face sheet 932 form openings to the tubular core 922. The tubular core 922 comprises a plurality of tubes 1026 (which may be referred to as, e.g., sound attenuation cells) extending between the first face sheet 932 and the second face sheet 936. Each tube 1026 of the plurality of tubes 1026 has a polygonal cross section 1026X. In one aspect, the tubular core 922 comprises a honeycomb core 922H configuration such that the acoustic attenuation panels 401 may each comprise a honeycomb sandwich structure 900. In this aspect, the tubes 1026 of the tubular core 922 may each have a honeycomb configuration. While the tubes 1026 and the tubular core 922 are described as having a honeycomb configuration, in other aspects, the tubes 1026 may have any suitable shape configured to attenuate sound emanating from the gas turbine engine 108 (FIG. 1).

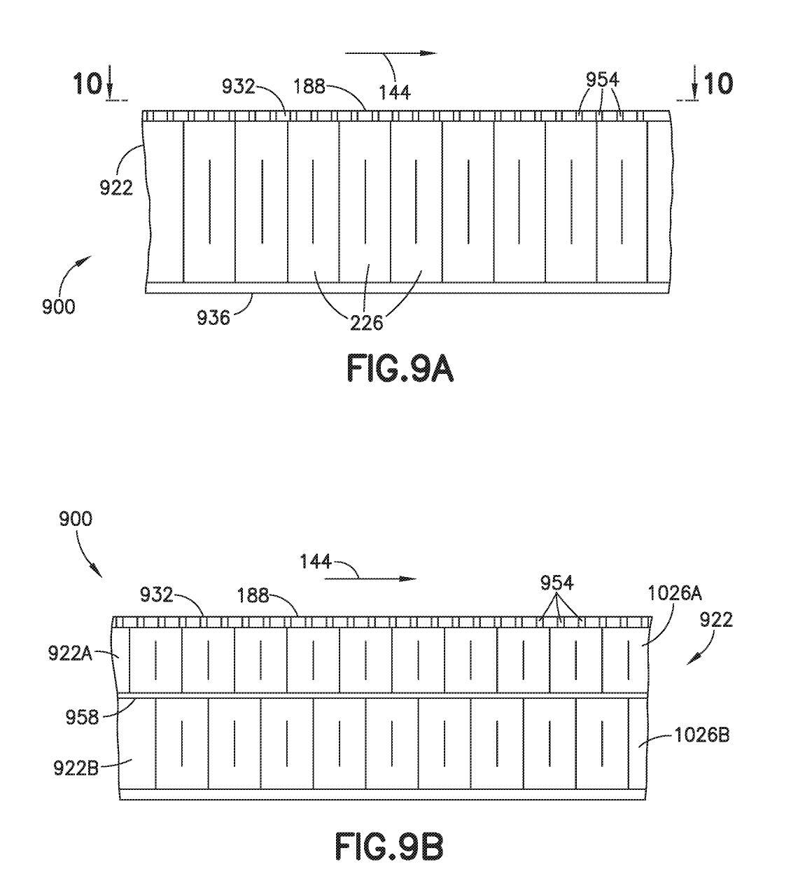

In one aspect, as illustrated in FIG. 9B, the tubular core 922 may include a septum 958 for acoustic attenuation purposes. The septum 958 may separate the tubular core 922 into two separate core portions 922A, 922B. The core portion 922A may include tubes 1026A that are in communication with the fluid flow 144 through the perforations 954. The core portion 922B includes tubes 1026B. The tubes 1026A, 1026B may be substantially similar to tubes 1026 described above. The septum 958 may be perforated in a manner substantially similar to that described above with respect to the first face sheet 932 so that the interior of the tubes 1026B are in communication with the interior of the tubes 1026A. The perforations 954 (in the first face sheet 932 and/or the septum 958) and the tubes 1026, 1026A, 1026B may be sized and shaped (or otherwise configured) to attenuate acoustic energy of the fluid flow 144 passing through the bifurcation assemblies 450A, 450B to effect a reduction in noise levels of the gas turbine engine 108 (FIG. 1) to any desired frequencies. The first face sheet 932, the second face sheet 936, the tubular core 922 and the septum 958 may be constructed of any suitable material configured to withstand the temperatures experienced within the gas turbine engine 108 (e.g., such as for example, about −40° F. (or lower) to about 800° F.-1000° F. (or higher)) and temperature gradients of up to about 400° F.-500° F. or greater across the surfaces of the face sheets. Examples of suitable materials include, but are not limited to titanium alloys, steel alloys, nickel alloys, or any other suitable alloy.

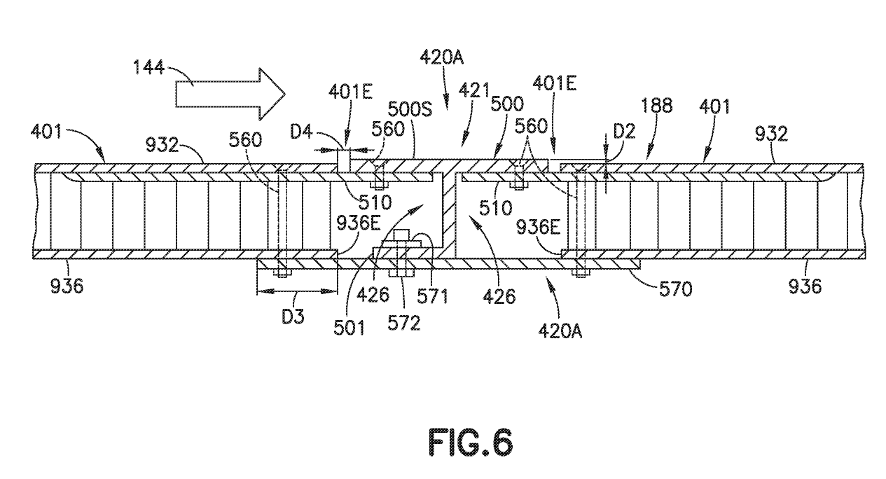

Referring again to FIGS. 4-8A, each acoustic attenuation panel 401 is removably coupled to the latticed frame 420A, 420B within a respective one of the plurality of bays 425 so that the acoustic attenuation panel 401 is configured to be coupled to and removed from the latticed frame 420A, 420B independent of other ones of the plurality of acoustic attenuation panels 401. At least one of the circumferentially extending frame members 421 and at least one of the longitudinally extending frame members 422 include at least one recessed portion 426 (see FIG. 6) that receives a peripheral edge 401E of the acoustic attenuation panel 401. Conversely, the at least one of the first face sheet 932 and the second face sheet 936 form a peripheral edge 932E, 936E (that forms a recess as will be described below) receives and couples with the latticed frame 420A, 420B. For example, at least one of the first face sheet 932 and the second face sheet 936 includes a coupling member 510 that extends past a peripheral edge 932E, 936E of, and formed by, the at least one of the first face sheet 932 and the second face sheet 936. The coupling member 510 may extend into the tubular core 922 any suitable distance so as to extend along the at least one of the first face sheet 932 and the second face sheet 936 between the at least one of the first face sheet 932 and the second face sheet 936 and the tubular core 922. The coupling member 510 may reinforce the at least one of the first face sheet 932 and the second face sheet 936 at the coupling between the respective acoustic attenuation panel 401 and the latticed frame 420A, 420B. In one aspect, as shown with respect to acoustic attenuation panel 401A in FIG. 5, the tubular core 922 may extend along the coupling member past the peripheral edge 932E, 936E of the at least one of the first face sheet 932 and the second face sheet 936; while in other aspects, as illustrated with respect to acoustic attenuation panel 401 in FIG. 5, the tubular core 922 may terminate at the peripheral edge 932E, 936E of the at least one of the first face sheet 932 and the second face sheet 936. Termination of the tubular core 922 at the peripheral edge 932E, 936E of the at least one of the first face sheet 932 and the second face sheet 936 may reduce costs by reducing the size of the acoustic attenuation panel 401 such that the tubular core 922 and perforated first face sheet 932 does not extend along the first flange member 500 where the perforations 954 (FIG. 9A) in the first face sheet 932 would be blocked from the fluid flow 144. The coupling member 510 and at least one of the first face sheet 932 and the second face sheet 936 for a recess that receives at least the first flange member 500 of the respective circumferentially extending frame members 421 and longitudinally extending frame members 422.

In one aspect, as illustrated in FIGS. 5 and 6, the acoustic attenuation panels 401, 401A may be coupled to the latticed frame 420A, 420B with any suitable removable fasteners 560 (e.g., screws, bolts, etc., noting that the placement of the removable fasteners 560 illustrated in the figures is exemplary and that there may be any suitable number of removable fasteners disposed at any suitable locations for coupling the acoustic attenuation panels 401, 401A to the latticed frame 420A, 420B). For example, the removable fasteners may be countersunk into the first flange member 500 in any suitable manner so that distance D between the end surface of the fastener 560E and the fluid flow surface 500S is negligible with respect to maintaining, for example, a laminar fluid flow along the fluid flow surface 188 of the acoustic attenuation assembly 400A, 400B. The distance D2 between the fluid flow surface 500S of the latticed frame 420A, 420B and the fluid flow surface of the first face sheet 932 is also negligible with respect to maintaining, for example, a laminar fluid flow along the fluid flow surface 188 of the acoustic attenuation assembly 400A, 400B such that the latticed frame 420A, 420B and a respective plurality of acoustic attenuation panels 401 form the fluid flow surface 188 of the fan duct wall 160W so that each of the latticed frame 420A, 420B and the plurality of acoustic attenuation panels 401 form at least a portion of a fluid flow passage 146P (that defines at least a portion of the duct fluid flow path 146) through the engine nacelle structure 112S. The distance D4 (see FIG. 6) extending along the fluid flow surface 188 is also negligible with respect to maintaining, for example, a laminar fluid flow along the fluid flow surface 188 of the acoustic attenuation assembly 400A, 400B. Because the distances D, D2, D4 are negligible with respect to maintaining laminar flow, the fluid flow surface 188 may be considered a smooth surface that effects a laminar fluid flow along the fan duct wall 160W. A smooth surface may be, for example, a surface that has no substantial steps in the surface that would cause Eddy fluid flow currents and induce turbulent flow (e.g., the steps in the surface are less than about 1/16 of an inch (about 1.6 mm), are less than about 1/32 of an inch (about 0.8 mm), or depending on a speed of fluid flow any other suitable distance that prevents the generation of Eddy fluid flow currents and turbulent flow).

A splice plate 570 may be provided at the second end 502E2 of the stanchion 502 where the splice plate 570 extends laterally, relative to the stanchion 502, over the acoustic attenuation panels 401, 401A any suitable predetermined distance D3. The splice plate 570 may be coupled to the second flange member 501 in any suitable manner, such as with a nut plate 571 (that is coupled to the second flange member 501) and a removable fastener 572 (e.g., bolt, screw, etc.). The splice plate 570, when coupled to the second flange member 501) may be in substantial contact with the acoustic attenuation panels 401, 401A so as to hold the acoustic attenuation panels 401, 401A substantially against the coupling surface 500C of the first flange member 500. The second splice plate 570 is removable from the second flange member 501 so that the acoustic attenuation panels 401, 401A may be removed from the latticed frame 420A, 420B substantially without interference from the latticed frame 420A, 420B and substantially without manipulation of the of the acoustic attenuation panels 401, 401A around portions of the circumferentially extending frame members 421 and at least one of the longitudinally extending frame members 422. It is noted that the acoustic attenuation panel 401 may be provided on the lateral side S1 of the stanchion 502 so that the acoustic attenuation panel 401 does not substantially interfere with the second flange member 501.

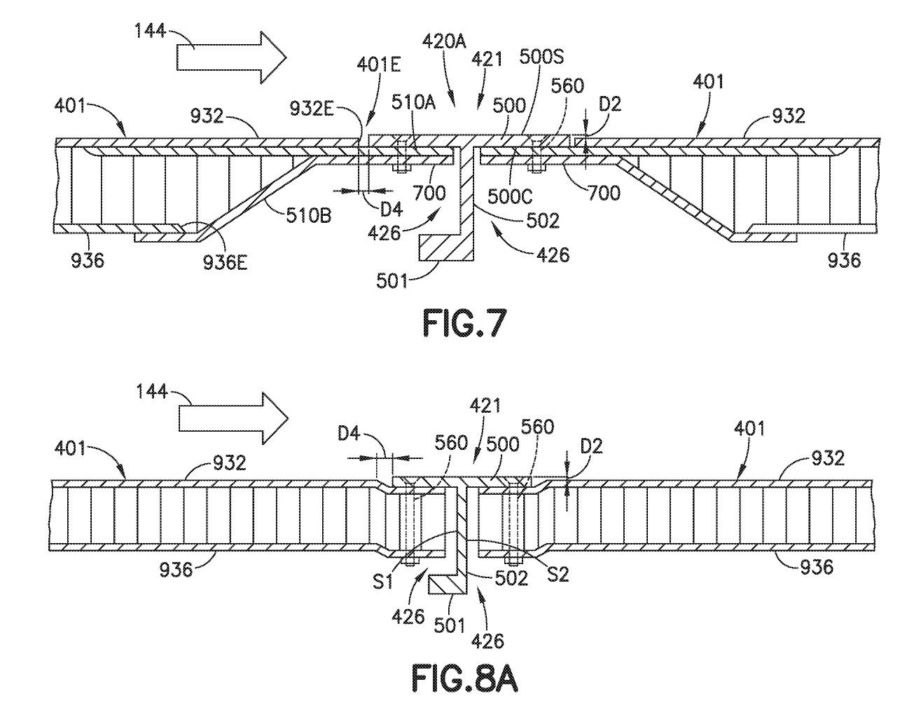

In another aspect, as illustrated in FIG. 7, the acoustic attenuation panel 401 may include more than one coupling member 510A, 510B. A first coupling member 510A may be coupled to the first face sheet 932 a manner similar to that described above with respect to coupling member 510. A second coupling member 510B may be coupled to the second face sheet 936 in a manner similar to that described above with respect to the coupling member 510. One or more of the first coupling member 510A and the second coupling member 510B may extend towards the other one of the first coupling member 510A and the second coupling member 510B to form a coupling flange 700. The coupling flange 700 may be in substantial contact with the coupling surface 500C of the first flange member 500, where the fastener 560 couples the coupling flange 700 to the coupling surface 500C in a manner similar to that described above.

In this aspect, the second flange member 501 is illustrated as a stiffening member for the stanchion 502. In other aspects, the splice plate 570 (FIGS. 5 and 6) may be coupled to the second flange member 501 in a manner substantially similar to that described above so that the splice plate couples with one or more of the second face sheet 936 and the second coupling member 510B to, at least in part, hold the coupling flange 700 in substantial contact with the coupling surface 500C. As illustrated in FIG. 7, at least one of the first coupling member 510A and the second coupling member 510B may be tapered relative to the second flange member 501 so as to provide clearance for coupling (e.g., installing) and de-coupling (e.g. removing) the respective acoustic attenuation panels 401 to and from the circumferentially extending frame members 421 and the longitudinally extending frame members 422 of the latticed frame 420A, 420B.

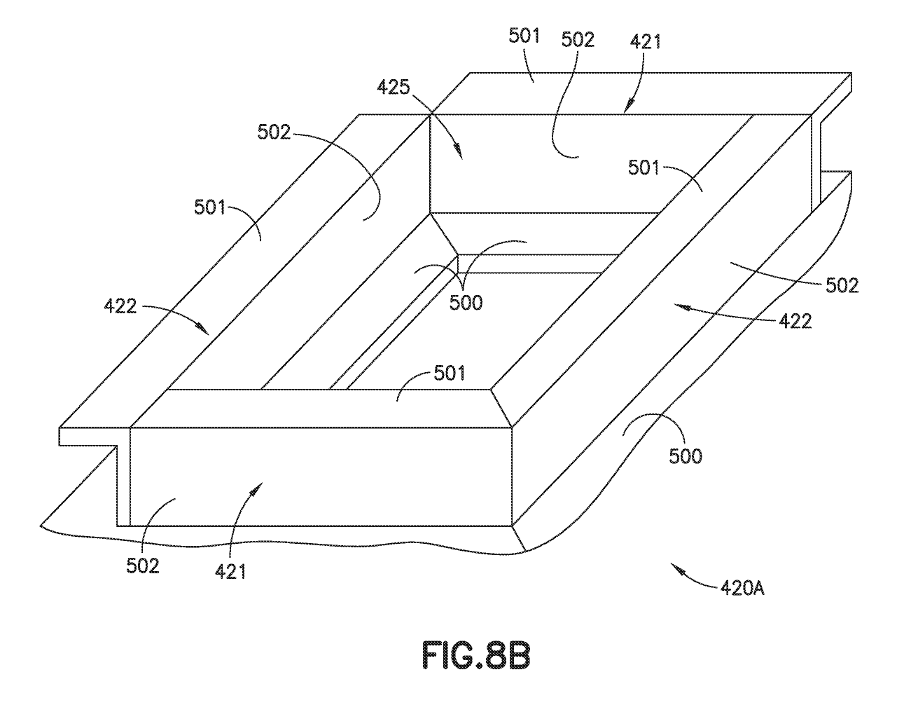

In yet another aspect, as illustrated in FIG. 8A, at least one of the first face sheet 932 and the second face sheet 936 may include a stepped or jogged surface that forms a recess that receives at least the first flange member 500 of the respective circumferentially extending frame members 421 and the longitudinally extending frame members 422 of the latticed frame 420A, 420B. As with the aspects described above, the second flange member 501 may extend to only one lateral side S1, S2 of the stanchion 502 to provide clearance between the circumferentially extending frame members 421 and the longitudinally extending frame members 422 of the latticed frame 420A, 420B and the acoustic attenuation panels 401 for coupling and de-coupling of the acoustic attenuation panels 401 to the latticed frame 420A, 420B. Referring to FIG. 8B, a partial side perspective view of the latticed frame 420A (latticed frame 420B may be substantially similar) is illustrated. The circumferentially extending frame members 421 and the longitudinally extending frame members 422 of the latticed frame 420A, 420B may be coupled to each other so that the bays 425 are formed with the second flange member 501 on two sides of the bay 425. Having the second flange member on two sides of the bay 425 allows for clearance between the acoustic attenuation panel 401 and the latticed frame 420A, 420B for the insertion/removal of the acoustic attenuation panel 401 to/from the respective bay 425.

Referring again to FIG. 4, when coupled to the latticed frame 420A, 420B, each acoustic attenuation panel 401 forms a shear web (also known as a shear resistant web or a shear panel) between the circumferentially extending frame members 421 and the longitudinally extending frame members 422 that form the respective one of the plurality of bays 425. For example, each acoustic attenuation panel, being coupled on all sides of the acoustic attenuation panel 401 to the sides of a respective bay 425 formed by the circumferentially extending frame members 421 and the longitudinally extending frame members 422, resists buckling up to a failure load (e.g., resists shear flow within the acoustic attenuation panel) to stiffen the latticed frame 420A, 420B of which the respective bay 425 is a part of. In another aspect, the acoustic attenuation panel 401 may form a diagonal-tension web and is placed in tension (e.g., where some folding of the acoustic attenuation panel occurs prior to the reaching the failure load) to stiffen the latticed frame 420A, 420B of which the respective bay 425 is a part of. In still other aspects, the acoustic attenuation panels 401 may be a combination of a shear web and a diagonal-tension web.

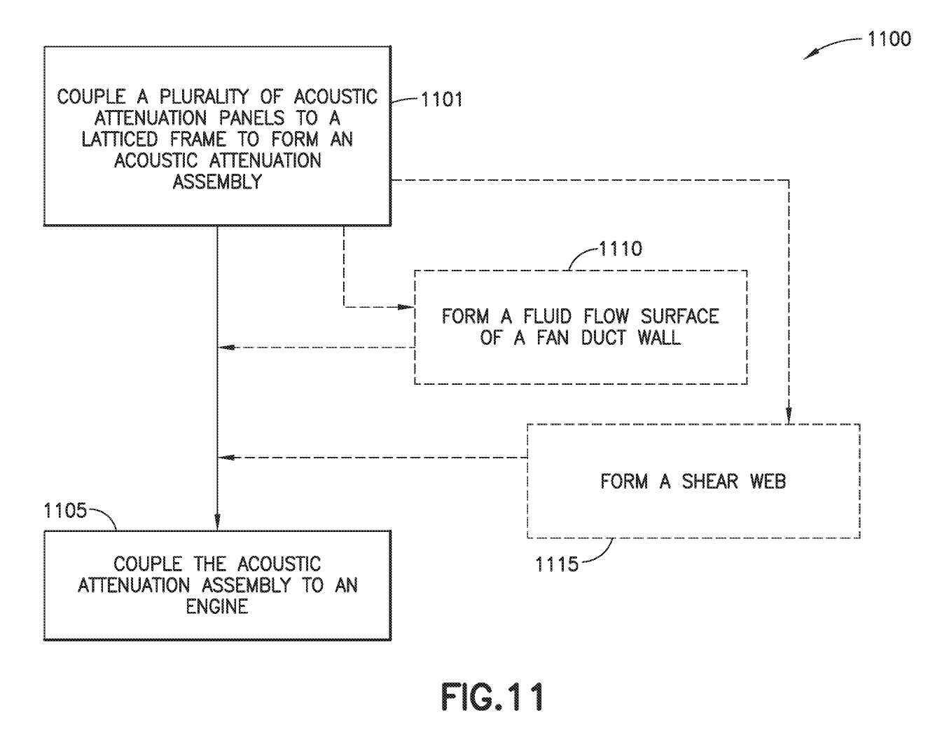

Referring to FIGS. 3, 4 and 11 an exemplary method 1100 for providing acoustic attenuation to a fan duct 160 of an engine nacelle 112 will be described in accordance with aspects of the present disclosure. The method 1100 includes removably coupling a plurality of acoustic attenuation panels 401 to a latticed frame 420A, 420B so as to form an acoustic attenuation assembly 400A, 400B (FIG. 11, Block 1101). As described above, the latticed frame 420A, 420B has circumferentially extending frame members 421 and longitudinally extending frame members 422 forming a plurality of bays 425 therebetween. Coupling the plurality of acoustic attenuation panels 401 to the latticed frame 420A, 420B includes forming a fluid flow surface 188 of the fan duct wall 160W (FIG. 11, Block 1110) so that each of the latticed frame 420A, 420B and the plurality of acoustic attenuation panels 401 form at least a portion of a fluid flow passage 146P through the engine nacelle structure 112S of the engine nacelle 112. Each acoustic attenuation panel 401 is coupled to the latticed frame 420A, 420B within a respective one of the plurality of bays 425 so that the acoustic attenuation panel 401 is configured to be coupled to and removed from the latticed frame 420A, 420B independent of other ones of the plurality of acoustic attenuation panels 401. For example, at least one of a first face sheet 932 and a second face sheet 936 of each acoustic attenuation panel 401 is received by the latticed frame 420A, 420B (and/or the latticed frame 420A, 420B is received by at least one of a first face sheet 932 and a second face sheet 936 of each acoustic attenuation panel 401) forming a smooth surface (e.g., the fluid flow surface 188) that effects a laminar fluid flow along the fan duct wall 160W. When coupled to the latticed frame 420A, 420B, the plurality of acoustic attenuation panels 401 form a shear web (FIG. 11, Block 1115) that spans a respective bay 425. The acoustic attenuation assembly 400A, 400B is coupled to the engine (FIG. 11, Block 1105) so that the latticed frame 420A, 420B, and the plurality of acoustic attenuation panels 401 removably coupled thereto, form a fan duct wall 160W of the fan duct 160 of the engine nacelle 112.

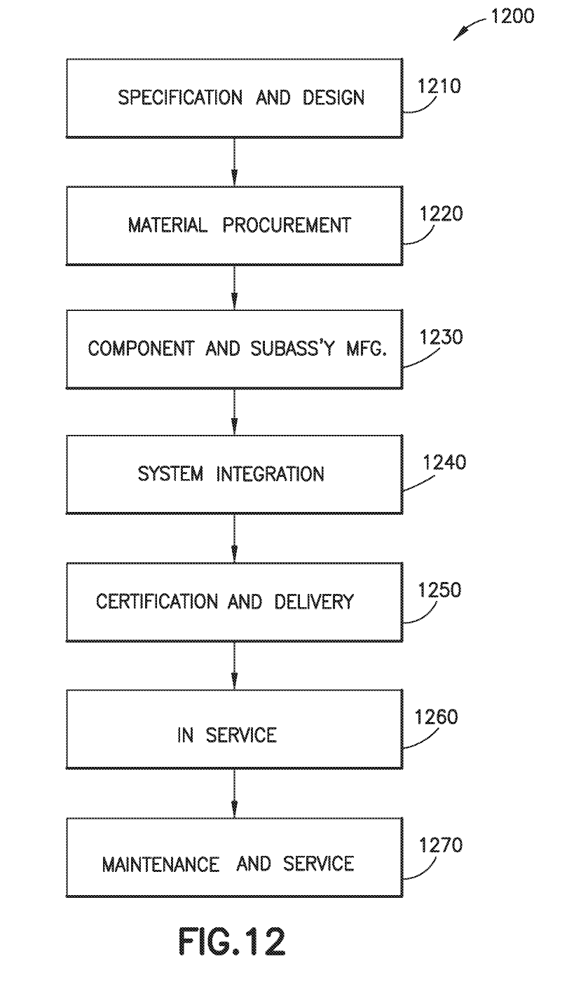

Referring to FIGS. 1 and 12, examples of the present disclosure may be described in the context of aircraft manufacturing and service method 1200 as shown in FIG. 12. In other aspects, the examples of the present disclosure may be applied in any suitable industry, such as e.g., automotive, maritime, aerospace, etc. as noted above, and as where sound attenuation of gas turbine engines may be needed. With respect to aircraft manufacturing, during pre-production, illustrative method 1200 may include specification and design (block 1210) of vehicle 100 and material procurement (block 1220). During production, component and subassembly manufacturing (block 1230) and system integration (block 1240) of vehicle 100 may take place. Thereafter, vehicle 100 may go through certification and delivery (block 1250) to be placed in service (block 1260). While in service, vehicle 100 may be scheduled for routine maintenance and service (block 1270). Routine maintenance and service may include modification, reconfiguration, refurbishment, etc. of one or more systems of vehicle 100 which may include and/or be facilitated by the acoustic attenuation system described herein.

Each of the processes of illustrative method 1200 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

The apparatus(es), system(s), and method(s) shown or described herein may be employed during any one or more of the stages of the manufacturing and service method 1200. For example, components or subassemblies corresponding to component and subassembly manufacturing (block 1230) may be fabricated or manufactured in a manner similar to components or subassemblies produced while vehicle 100 is in service (block 1260). Similarly, one or more examples of the apparatus or method realizations, or a combination thereof, may be utilized, for example and without limitation, while vehicle 100 is in service (block 1260) and/or during maintenance and service (block 1270).

The following are provided in accordance with the aspects of the present disclosure:

A1. An engine nacelle structure comprising:

a fan duct having a fan duct wall, the fan duct wall including

a latticed frame having circumferentially extending frame members and longitudinally extending frame members, the circumferentially extending frame members and longitudinally extending frame members form a plurality of bays therebetween, and

a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic panels.

A2. The engine nacelle structure of paragraph A1, wherein the latticed frame and the plurality of acoustic attenuation panels form a fluid flow surface of the fan duct wall so that each of the latticed frame and the plurality of acoustic panels form at least a portion of a fluid flow passage through the engine nacelle structure.

A3. The engine nacelle structure of paragraph A2, wherein the fluid flow surface is a smooth surface that effects a laminar fluid flow along the fan duct wall.

A4. The engine nacelle structure of paragraph A1, wherein the fan duct wall comprises an arcuate portion and at least one flange portion extending radially from the arcuate portion.

A5. The engine nacelle structure of paragraph A4, wherein the arcuate portion includes at least two bays.

A6. The engine nacelle structure of paragraph A4, wherein the at least one flange portion includes at least one bay.

A7. The engine nacelle structure of paragraph A1, wherein the fan duct wall comprises an inner duct wall and bifurcation assembly.

A8. The engine nacelle structure of paragraph A1, wherein the plurality of acoustic attenuation panels are coupled to the latticed frame with removable fasteners.

A9. The engine nacelle structure of paragraph A1, wherein each of the plurality of acoustic panels comprises:

a first face sheet, the first face sheet including perforations that interface with fluid flow through the engine nacelle structure;

a second face sheet; and

a tubular core disposed between the first face sheet and the second face sheet, where the perforations form openings to the tubular core.

A10. The engine nacelle structure of paragraph A9, wherein at least one of the first face sheet and the second face sheet form a peripheral edge that receives and couples with the latticed frame.

A11. The engine nacelle structure of paragraph A9, wherein:

at least one of the first face sheet and the second face sheet form a peripheral edge; and

at least one of the circumferentially extending frame members and at least one of the longitudinally extending frame members include a recessed portion that receives the peripheral edge.

A12. The engine nacelle structure of paragraph A9, wherein the tubular core comprises a plurality of tubes extending between the first face sheet and the second face sheet.

A13. The engine nacelle structure of paragraph A12, wherein each tube of the plurality of tubes has a polygonal cross section.

A14. The engine nacelle structure of paragraph A9, wherein the tubular core comprises a honeycomb core.

A15. The engine nacelle structure of paragraph A1, wherein each acoustic attenuation panel forms a shear web between the circumferentially extending frame members and longitudinally extending frame members that form the respective one of the plurality of bays.

A16. The engine nacelle structure of paragraph A1, wherein the fan duct wall is a bifurcated wall.

B1. A vehicle comprising:

a frame; and

at least one gas turbine engine coupled to the frame, the at least one gas turbine engine having a fan duct wall, the fan duct wall including

a latticed frame having circumferentially extending frame members and longitudinally extending frame members, the circumferentially extending frame members and longitudinally extending frame members form a plurality of bays therebetween, and

a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic panels.

B2. The vehicle of paragraph B1, wherein the latticed frame and the plurality of acoustic attenuation panels form a fluid flow surface of the fan duct wall so that each of the latticed frame and the plurality of acoustic panels form at least a portion of a fluid flow passage through an engine nacelle structure.

B3. The vehicle of paragraph B2, wherein the fluid flow surface is a smooth surface that effects a laminar fluid flow along the fan duct wall.

B4. The vehicle of paragraph B1, wherein the fan duct wall comprises an arcuate portion and at least one flange portion extending radially from the arcuate portion.

B5. The vehicle of paragraph B4, wherein the arcuate portion includes at least two bays.

B6. The vehicle of paragraph B4, wherein the at least one flange portion includes at least one bay.

B7. The vehicle of paragraph B1, wherein the fan duct wall comprises an inner duct wall and bifurcation assembly.

B8. The vehicle of paragraph B1, wherein the plurality of acoustic attenuation panels are coupled to the latticed frame with removable fasteners.

B9. The vehicle of paragraph B1, wherein each of the plurality of acoustic panels comprises:

a first face sheet, the first face sheet including perforations that interface with fluid flow through an engine nacelle structure;

a second face sheet; and

a tubular core disposed between the first face sheet and the second face sheet, where the perforations form openings to the tubular core.

B10. The vehicle of paragraph B9, wherein at least one of the first face sheet and the second face sheet form a peripheral edge that receives and couples with the latticed frame.

B11. The vehicle of paragraph B9, wherein:

at least one of the first face sheet and the second face sheet form a peripheral edge; and

at least one of the circumferentially extending frame members and at least one of the longitudinally extending frame members include a recessed portion that receives the peripheral edge.

B12. The vehicle of paragraph B9, wherein the tubular core comprises a plurality of tubes extending between the first face sheet and the second face sheet.

B13. The vehicle of paragraph B12, wherein each tube of the plurality of tubes has a polygonal cross section.

B14. The vehicle of paragraph B9, wherein the tubular core comprises a honeycomb core.

B15. The vehicle of paragraph B1, wherein each acoustic attenuation panel forms a shear web between the circumferentially extending frame members and longitudinally extending frame members that form the respective one of the plurality of bays.

B16. The vehicle of paragraph B1, wherein the fan duct wall is a bifurcated wall.

B17. The vehicle of paragraph B1, wherein the vehicle comprises an aircraft.

C1. A method for providing acoustic attenuation to a fan duct of an engine nacelle, the method comprising:

removably coupling a plurality of acoustic attenuation panels to a latticed frame so as to form an acoustic attenuation assembly, where the latticed frame has circumferentially extending frame members and longitudinally extending frame members forming a plurality of bays therebetween, and each acoustic attenuation panel is coupled to the latticed frame within a respective one of the plurality of bays so that the acoustic attenuation panel is configured to be coupled to and removed from the latticed frame independent of other ones of the plurality of acoustic panels; and

coupling the acoustic attenuation assembly to the engine nacelle so that the latticed frame, and the plurality of acoustic attenuation panels removably coupled thereto, form a fan duct wall of the fan duct of the engine nacelle.

C2. The method of paragraph C1, wherein removably coupling the plurality of acoustic attenuation panels to the latticed frame includes forming a fluid flow surface of the fan duct wall so that each of the latticed frame and the plurality of acoustic panels form at least a portion of a fluid flow passage through an engine nacelle structure of the engine nacelle.

C3. The method of paragraph C1, wherein at least one of a first face sheet and a second face sheet of each acoustic attenuation panel is received by the latticed frame forming a smooth surface that effects a laminar fluid flow along the fan duct wall.

C4. The method of paragraph C1, wherein the latticed frame is received by at least one of a first face sheet and a second face sheet of each acoustic attenuation panel forming a smooth surface that effects a laminar fluid flow along the fan duct wall.

C5. The method of paragraph C1, wherein the plurality of acoustic attenuation panels form a shear web when removably coupled to the latticed frame.

In the figures, referred to above, solid lines, if any, connecting various elements and/or components may represent mechanical, electrical, fluid, optical, electromagnetic, wireless and other couplings and/or combinations thereof. As used herein, “coupled” means associated directly as well as indirectly. For example, a member A may be directly associated with a member B, or may be indirectly associated therewith, e.g., via another member C. It will be understood that not all relationships among the various disclosed elements are necessarily represented. Accordingly, couplings other than those depicted in the drawings may also exist. Dashed lines, if any, connecting blocks designating the various elements and/or components represent couplings similar in function and purpose to those represented by solid lines; however, couplings represented by the dashed lines may either be selectively provided or may relate to alternative examples of the present disclosure. Likewise, elements and/or components, if any, represented with dashed lines, indicate alternative examples of the present disclosure. One or more elements shown in solid and/or dashed lines may be omitted from a particular example without departing from the scope of the present disclosure. Environmental elements, if any, are represented with dotted lines. Virtual (imaginary) elements may also be shown for clarity. Those skilled in the art will appreciate that some of the features illustrated in the figures, may be combined in various ways without the need to include other features described in the figures, other drawing figures, and/or the accompanying disclosure, even though such combination or combinations are not explicitly illustrated herein. Similarly, additional features not limited to the examples presented, may be combined with some or all of the features shown and described herein.

In FIGS. 11 and 12, referred to above, the blocks may represent operations and/or portions thereof and lines connecting the various blocks do not imply any particular order or dependency of the operations or portions thereof. Blocks represented by dashed lines indicate alternative operations and/or portions thereof. Dashed lines, if any, connecting the various blocks represent alternative dependencies of the operations or portions thereof. It will be understood that not all dependencies among the various disclosed operations are necessarily represented. FIGS. 11 and 12, and the accompanying disclosure describing the operations of the method(s) set forth herein should not be interpreted as necessarily determining a sequence in which the operations are to be performed. Rather, although one illustrative order is indicated, it is to be understood that the sequence of the operations may be modified when appropriate. Accordingly, certain operations may be performed in a different order or substantially simultaneously. Additionally, those skilled in the art will appreciate that not all operations described need be performed.

In the following description, numerous specific details are set forth to provide a thorough understanding of the disclosed concepts, which may be practiced without some or all of these particulars. In other instances, details of known devices and/or processes have been omitted to avoid unnecessarily obscuring the disclosure. While some concepts will be described in conjunction with specific examples, it will be understood that these examples are not intended to be limiting.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

Reference herein to “one example” means that one or more feature, structure, or characteristic described in connection with the example is included in at least one implementation. The phrase “one example” in various places in the specification may or may not be referring to the same example.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Different examples of the apparatus(es) and method(s) disclosed herein include a variety of components, features, and functionalities. It should be understood that the various examples of the apparatus(es), system(s), and method(s) disclosed herein may include any of the components, features, and functionalities of any of the other examples of the apparatus(es) and method(s) disclosed herein in any combination, and all of such possibilities are intended to be within the scope of the present disclosure.

Many modifications of examples set forth herein will come to mind to one skilled in the art to which the present disclosure pertains having the benefit of the teachings presented in the foregoing descriptions and the associated drawings.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

What is claimed is:

1. An engine nacelle structure comprising:
a fan duct having a fan duct wall, the fan duct wall including
a latticed frame having circumferentially extending frame members and longitudinally extending frame members, the circumferentially extending frame members and longitudinally extending frame members form a plurality of bays therebetween, and
a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic attenuation panels.

2. The engine nacelle structure of claim 1, wherein the latticed frame and the plurality of acoustic attenuation panels form a fluid flow surface of the fan duct wall so that each of the latticed frame and the plurality of acoustic attenuation panels form at least a portion of a fluid flow passage through the engine nacelle structure.

3. The engine nacelle structure of claim 2, wherein the fluid flow surface is a smooth surface that effects a laminar fluid flow along the fan duct wall.

4. The engine nacelle structure of claim 1, wherein the fan duct wall comprises an arcuate portion and at least one flange portion extending radially from the arcuate portion.

5. The engine nacelle structure of claim 4, wherein the arcuate portion includes at least two bays.

6. The engine nacelle structure of claim 4, wherein the at least one flange portion includes at least one bay.

7. The engine nacelle structure of claim 1, wherein the plurality of acoustic attenuation panels are coupled to the latticed frame with removable fasteners.

8. The engine nacelle structure of claim 1, wherein each acoustic attenuation panel forms a shear web between the circumferentially extending frame members and longitudinally extending frame members that form the respective one of the plurality of bays.

9. A vehicle comprising:
a frame; and
at least one gas turbine engine coupled to the frame, the at least one gas turbine engine having a fan duct wall, the fan duct wall including
a latticed frame having circumferentially extending frame members and longitudinally extending frame members, the circumferentially extending frame members and longitudinally extending frame members form a plurality of bays therebetween, and
a plurality of acoustic attenuation panels, each acoustic attenuation panel being removably coupled to the latticed frame within a respective one of the plurality of bays so that the acoustic attenuation panel is configured to be coupled to and removed from the latticed frame independent of other ones of the plurality of acoustic attenuation panels.

10. The vehicle of claim 9, wherein the latticed frame and the plurality of acoustic attenuation panels form a fluid flow surface of the fan duct wall so that each of the latticed frame and the plurality of acoustic attenuation panels form at least a portion of a fluid flow passage through an engine nacelle structure.

11. The vehicle of claim 9, wherein each of the plurality of acoustic attenuation panels comprises:
a first face sheet, the first face sheet including perforations that interface with fluid flow through an engine nacelle structure;
a second face sheet; and
a tubular core disposed between the first face sheet and the second face sheet, where the perforations form openings to the tubular core.

12. The vehicle of claim 11, wherein at least one of the first face sheet and the second face sheet form a peripheral edge that receives and couples with the latticed frame.

13. The vehicle of claim 11, wherein:
at least one of the first face sheet and the second face sheet form a peripheral edge; and
at least one of the circumferentially extending frame members and at least one of the longitudinally extending frame members include a recessed portion that receives the peripheral edge.

14. The vehicle of claim 11, wherein the tubular core comprises a honeycomb core.

15. The vehicle of claim 9, wherein the vehicle comprises an aircraft.

16. A method for providing acoustic attenuation to a fan duct of an engine nacelle, the method comprising:
removably coupling a plurality of acoustic attenuation panels to a latticed frame so as to form an acoustic attenuation assembly, where
the latticed frame has circumferentially extending frame members and longitudinally extending frame members forming a plurality of bays therebetween, and
each acoustic attenuation panel is coupled to the latticed frame within a respective one of the plurality of bays so that the acoustic attenuation panel is configured to be coupled to and removed from the latticed frame independent of other ones of the plurality of acoustic attenuation panels; and
coupling the acoustic attenuation assembly to the engine nacelle so that the latticed frame, and the plurality of acoustic attenuation panels removably coupled thereto, form a fan duct wall of the fan duct of the engine nacelle.

17. The method of claim 16, wherein removably coupling the plurality of acoustic attenuation panels to the latticed frame includes forming a fluid flow surface of the fan duct wall so that each of the latticed frame and the plurality of acoustic attenuation panels form at least a portion of a fluid flow passage through an engine nacelle structure of the engine nacelle.

18. The method of claim 16, wherein at least one of a first face sheet and a second face sheet of each acoustic attenuation panel is received by the latticed frame forming a smooth surface that effects a laminar fluid flow along the fan duct wall.

19. The method of claim 16, wherein the latticed frame is received by at least one of a first face sheet and a second face sheet of each acoustic attenuation panel forming a smooth surface that effects a laminar fluid flow along the fan duct wall.

20. The method of claim 16, wherein the plurality of acoustic attenuation panels form a shear web when removably coupled to the latticed frame.
